(19) United States
(12) Patent Application Publication
(10) Pub. No.: US 2004/0184148 A1
(43) Pub. Date: Sep. 23, 2004

(54) Integrated micro-optic architecture for combining and depolarizing plural polarized laser beams

(75) Inventors: Kok-Wai Chang, Los Altos, CA (US); Jyehong Chen, Mt. Holly, NJ (US); Kuochou Tai, Fremont, CA (US); Gonzalo Wills, Ottawa (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignees: JDS UNIPHASE CORPORATION, San Jose, CA; JDS UNIPHASE INC., Ottawa (CA)

(21) Appl. No.: 10/786,261

(22) Filed: Feb. 25, 2004

Related U.S. Application Data
(63) Continuation-in-part of application No. 10/152,657, filed on May 21, 2002, now abandoned.
(60) Provisional application No. 60/291,982, filed on May 21, 2001.

(51) Int. Cl. G02F 1/13; G02B 5/30; G02B 27/28

(52) U.S. Cl. 359/497; 359/494

(57) ABSTRACT

A multimode laser beam depolarization and combining architecture integrates a combiner for polarized multimode light beams with a multimode beam depolarizer, that produces a composite depolarized output beam optimized for application to a Raman optical amplifier. A high-order depolarizing 45° waveplate is used to effectively depolarize multimode laser beams produced by a Fabry-Perot (FP) laser. The high-order 45° waveplate has a length that achieves multi mode dispersion-dependent depolarization of the beam over its travel path through the crystal, and may comprise a birefringent material such as YVO₄ having a large difference between its extraordinary and ordinary indices of refraction.

### CROSS-REFERENCE TO RELATED APPLICATION

This application is a Continuation-in-part application and claims priority from U.S. patent application Ser. No. 10/152,657 filed May 21, 2002 and from U.S. provisional application 60/291,982 filed May 21, 2001

### FIELD OF THE INVENTION

The present invention relates in general to optical communication systems and components therefor, and is particularly directed to a new and improved laser beam depolarizer for depolarizing a single or multiple laser beams. The depolarizer may be integrated with a multi-beam combiner, to realize a micro-optic combiner-depolarizer architecture whose output is a composite depolarized multi-laser beam optimized for application to a downstream beam processing device, such as a Raman amplifier.

### BACKGROUND OF THE INVENTION

A variety of optical signal processing applications require that the input beam have as close as possible to (ideally) zero percent degree of polarization (DoP). As a non-limiting example, to obtain efficient coupling of a laser beam into a Raman amplifier, the DoP of the beam should be less than ten percent; optimal gain performance of a Raman amplifier is achieved if the input beam is completely depolarized. In a number of applications, a Raman amplifier may be used to amplify a composite beam containing a plurality of (e.g., two) laser beam components having the same or relatively close to the same wavelength, and respective linear polarizations. In this case, the DoP of the composite beam will still be substantial and be either linear, circular or elliptical, depending upon the relative phase of the two laser beams.

Because such a composite laser beam is less than 100% depolarized, the amplification efficiency of the Raman amplifier will be less than optimal, since the orientation of vibrational modes within the optical fiber is random in nature; efficient Raman amplification requires that the polarization of pumping light be random as well. In order to create sufficient gain in the amplifier, it is necessary to effectively depolarize the composite beam (to less than ten percent, as pointed out above).

### SUMMARY OF THE INVENTION

In accordance with the present invention, this objective is achieved by a new and improved laser beam depolarization and combining architecture, which integrates a combiner for polarized multimode light beams with a multimode beam depolarizer, that is effective to produce a composite output beam that is effectively depolarized, and thereby optimized for application to a downstream device, such as a Raman optical amplifier.

As will be detailed below, in a number of embodiments, the invention uses a high-order depolarizing 45° waveplate to effectively depolarize a single multimode laser beam or plural multimode laser beams, such as those produced by a Fabry-Perot (FP) laser. The high-order 45° waveplate has a length sufficient to achieve multi mode dispersion-dependent depolarization of the beam over its travel path through the crystal, and may comprise a birefringent material such as YVO₄ having a large difference between its extraordinary and ordinary indices of refraction. The Poincaré sphere-based depolarization characteristic exhibited by the depolarizing waveplate causes the polarizations of various modes of a multimode beam to rotate differently, so that it creates a rapidly varying polarization of the respective mode components of the multimode beam traveling through it over near wavelengths of the laser beam, and thereby increases the degree of coupling to optical phonons in the glass.

The length of the high order waveplate is established in accordance with the mode spacing of the incident beam, so that the DoP of output beam exiting the 45° waveplate will fall within the desired target DoP range of less than ten percent, and thereby provide for efficient coupling of the depolarized or polarization-‘scrambled’ laser beam with a downstream Raman amplifier. As a non-limiting example, for a typical 2 mm long, Raman pump Fabry Perot laser chip having a mode spacing of its output beam on the order of from 0.15 to 0.20 nanometers (nm), the required length of the depolarization YVO₄ waveplate is on the order of 16 mm. Because the optic axial length or thickness of such a high order depolarizing crystal is relatively small, it may be readily integrated with a compact volume (micro-optic) beam processing architecture that allows various beam components of a single composite beam to be effectively depolarized, so that DoP of the resulting composite beam satisfies less than ten percent DoP requirement for efficient Raman amplifier coupling.

In a first embodiment, a pair of polarization maintaining optical fibers carrying first and second mutually orthogonally linearly polarized multimode laser beams are terminated by way of collimator elements of a combiner/depolarizer support structure. The outputs of the two collimators are directed upon separate locations of a polarization-dependent beam combiner/splitter (PBS) or walk off crystal element. The crystal orientation of the PBS element is such as to allow one of beams to travel therethrough along its input beam travel path, exiting the crystal at a location that is path-coincident with its entry location.

On the other hand, the travel path of the orthogonally polarized beam is spatially translated through the crystal element toward the travel path of the untranslated beam. The length of PBS element is defined such that the translated beam intersects the path of the untranslated beam and exits the crystal at the same exit location. This makes the two (mutually polarized) laser beams path-coincident as a composite a common travel path. The composite beam traveling has normal incidence upon a polarization-scrambling, high-order 45° having a length defined, so that the DoP of the composite beam emerging its rear surface will very small and ensure efficient coupling with a downstream Raman amplifier. The depolarized composite beam may be injected into an optical fiber coupler which couples the beam to the Raman amplifier.

The second embodiment has the same front end combining components as the first embodiment, but employs a reduced thickness half-wave plate cascaded with splitter and combiner crystal elements, which increase the differential path length/delay between the two beam components, to produce the intended polarization-dispersion effects on a multimode laser beam. In the second embodiment, the composite beam exiting the first walk off crystal element is incident upon a relatively thin 22.5° half-wave plate. This half-wave plate reverses the planes of polarization of the two input beams (rotating their polarizations by 45°) without causing beam displacement.

The polarization-modified composite beam exiting the 22.5° half-wave plate impinges at normal incidence upon a further PBS crystal element, which serves as a depolarizer, splitting the two beam components into separate travel path directions, so as to impart a transmission delay of one polarization component relative to the other polarization component. The two differentially delayed polarization beam components are incident upon respective spaced apart locations of a downstream PBS beam combiner.

The length of the downstream PBS beam combiner is the same as that of the depolarizer PBS crystal element, so that the two beam components will emerge the downstream combiner at the same exit location making the two (mutually orthogonally polarized (p)/(s)) beam components path coincident. Because the lengths of the two PBS elements increase the length of the travel path of one-half the optical power in one path over one-half the optical power in the other beam path, there is an effective polarization dispersion of the two components of the beam, so that the DoP of the composite beam exiting the downstream crystal element is substantially reduced, yielding the desired combined and depolarized output beam.

The third (micro-optic) embodiment of the invention employs an optically cascaded set of relatively thin beam-modifying crystal elements. An upstream the crystal element allows the beam of a first polarization incident at a first location to pass straight therethrough along its input beam travel path, whereas a second, orthogonally polarized beam incident at a second location is spatially translated through the crystal element toward the beam travel path of the first beam. The two parallel (and more closely spaced) beams are incident upon the crystal element configured as a 45° half-wave plate element, having its optical axis rotated at 45° relative to the directions of polarization of the two (physically closer) input beams. This second crystal element effectively reverses the planes of polarization of the two input beams without beam displacement.

The two polarization-reversed beams are then incident upon a third crystal element identical to the first crystal element and its optical axis oriented at 45° relative to its input and exit faces. The third crystal element allows the beam of a first polarization to pass therethrough along its input beam travel path, while causing the travel path of the orthogonally polarized beam to be spatially translated toward the beam travel path of the first beam. The thickness of the third crystal element is such that the two beams exit the crystal at a common location, that is generally in the middle of the crystal to produce composite beam containing mutually orthogonal polarization beam components. The composite beam is then incident on a high-order depolarizing 45° waveplate, such as a YVO₄ waveplate, the length of which is such as to produce a combined depolarized beam.

In a fourth embodiment of the invention, the cascaded crystal elements of the third embodiment are configured to provide reverse path isolation.

Fifth and sixth embodiments of the invention use a reduced thickness half-wave plate cascaded with elements, which increase the differential path length/delay between the two beam components, as in the second embodiment. In particular, respective like polarizations of a pair of multimode beams are directed upon spaced apart locations of a 50/50 beam splitter block. The beam splitter produces two composite beams, each containing half of each input polarization, traveling along differential phase delay beam paths. The longer path passes through a 45° half-wave plate that effectively reverses the plane of polarization of its composite beam. These two orthogonally polarized beams are then directed to spaced apart locations of a polarization-dependent combiner block. As a result of the different polarizations and differential phase delays of the beams of the two paths, the DoP of the composite beam output by the combiner block is reduced to a value for coupling into a device such as Raman amplifier.

In accordance with a preferred embodiment of the invention, there is provided, a polarization dependent depolarizer for depolarizing two linear orthogonally polarized incoming beams of light, comprising:

a) a housing having polarization maintaining input optical fibers for providing polarized light into the housing and an output optical fiber for directing a single depolarized beam out of the housing;

b) a polarization beam combiner disposed within the housing and oriented to receive the two linear orthogonal components of light exiting the input optical fibers and for combining the two beams into a single beam;

c) a first high order depolarizing waveplate having a principle optical axis and having a length along said axis so as to achieve depolarization of a beam propagating entirely along said axis such that the DoP of the beam exiting the first high order depolarizing waveplate is less than 20 percent, whereby different wavelengths of light in said beam will have a different polarization than other wavelengths in said beam, said waveplate having ordinary and extraordinary indices of refraction, a difference of said indices of refraction being at least 0.1, said first high order depolarizing waveplate being oriented such that orthogonally linear components of the beam received from the polarization beam combiner are at substantially 45 degrees to the optical axis of the first high order depolarizing waveplate.

### BRIEF DESCRIPTION OF THE DRAWINGS

FIG. 1 diagrammatically illustrates a polarized multimode laser beam directed through a high-order 45° waveplate;

FIGS. 2 and 3 show the Poincaré sphere-based depolarization characteristic of a depolarizing waveplate;

FIGS. 4-9 diagrammatically illustrate respective first through sixth embodiments of an integrated beam combiner and depolarizer architecture of the invention; and,

FIG. 10 is a view of an packaged polarization depolarizer in accordance with a preferred embodiment of the invention wherein isolation is provided.

FIG. 11 is a plot of depolarization versus thickness for a crystal having a difference in refractive index between the extraordinary and the ordinary axes or 0.2.

### DETAILED DESCRIPTION

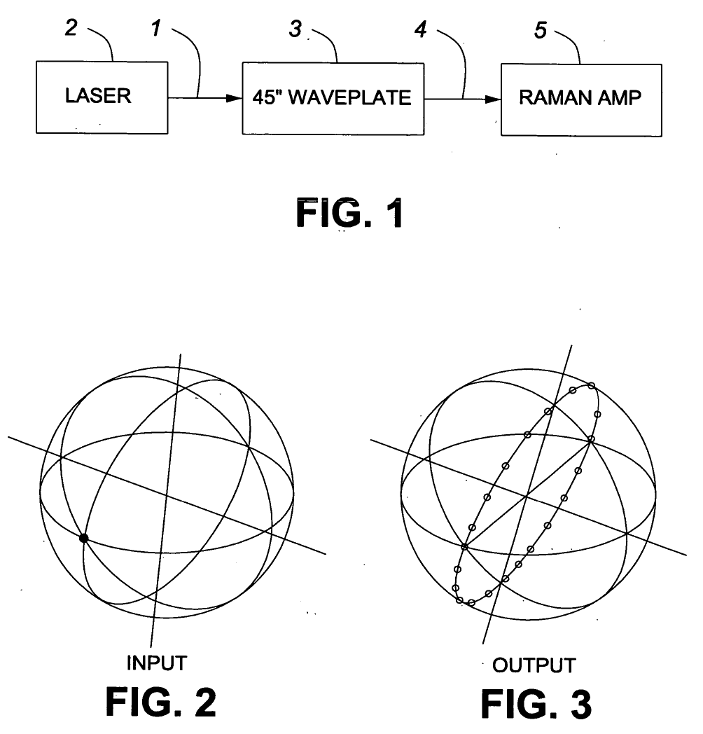

As pointed out briefly above, a first aspect of the present invention is the use of a high-order depolarizing 45° waveplate to effectively depolarize a single multimode laser beam or plural multimode laser beams, such as those produced by a Fabry-Perot (FP) laser. For this purpose, as shown diagrammatically in FIG. 1, a (linearly) polarized multimode beam 1 produced by a (FP) laser 2 is directed through a high-order 45° waveplate 3 having a length that is sufficient to achieve multi mode dispersion-dependent depolarization of the beam 1 over its travel path through the crystal. For this purpose, the high order waveplate 3 preferably comprises a birefringent material having a large difference between its extraordinary and ordinary indices of refraction. As a non-limiting example, multiple order waveplate 3 may comprise a YVO₄ waveplate.

As shown in FIGS. 2 and 3, the Poincaré sphere-based depolarization characteristic of depolarizing waveplate 3 causes the polarizations of various modes of the beam produced by the FP laser 2 to rotate differently, so that it creates a rapidly varying polarization of the respective mode components of the multimode beam traveling through it over near wavelengths of the laser beam, and thereby increases the degree of coupling to optical phonons in the glass.

The length of the high order waveplate 3 is established in accordance with the mode spacing of the incident beam, so that DoP of the output beam 4 exiting the 45° waveplate will fall within the desired target DoP range of less than ten percent, and thereby provide for efficient coupling of the depolarized or polarization-‘scrambled’ laser beam with a downstream Raman amplifier 5. As a non-limiting example, for a typical 2 mm long, Raman pump Fabry-Perot laser chip having a mode spacing of its output beam on the order of from 0.15 to 0.20 nanometers (nm), the required length of a depolarization YVO₄ waveplate 3 is on the order of 16 mm.

Because the optic axial length or thickness of such a high order depolarizing crystal is relatively small, it may be readily integrated with a compact volume (micro-optic) beam processing architecture that allows various beam components of a single composite beam to be effectively depolarized, so that DoP of the resulting composite beam satisfies less than ten percent DoP requirement for efficient Raman amplifier coupling.

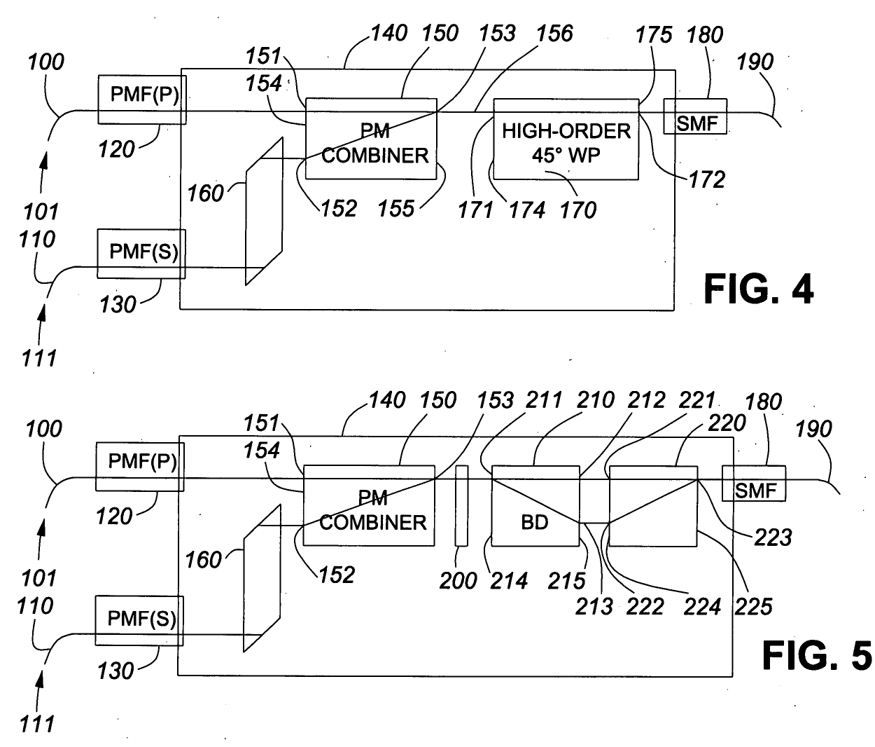

A first embodiment of such an integrated beam combiner and depolarizer architecture is diagrammatically illustrated in FIG. 4, wherein polarization maintaining fibers (PMFs) 100 and 110 carrying first and second mutually orthogonally linearly polarized multimode laser beams are terminated by way of collimator elements 120 and 130, respectively, of a combiner/depolarizer support structure 140. The two mutually orthogonally polarized light beams 101 and 111 carried by the fibers 100 and 110 may be sourced from respective multimode lasers, such as a pair of 2 mm Raman Fabry-Perot lasers, of the type-referenced above, the respective outputs beams have mutually orthogonal polarizations (p) and (s). The wavelengths of the two multimode laser beams may be different, also.

Collimator element 120 is positioned to direct the (p) polarized laser beam 101 transported by the fiber 100 at normal incidence upon a first location 151 of a generally flat input face 154 of a polarization-dependent beam combiner/splitter (PBS) or ‘walk off’ crystal element 150. The PBS element 150 may comprise a conventional birefringent crystal, made from a material such as rutile, (TiO₂), yttrium vanadate (YVO₄), lithium niobate (LiNiO₃) and calcite (CaCO₃), and the like, having its optical axis oriented at 45° relative to parallel input and exit faces 154 and 155, as shown. Similarly, the collimator element 130 is positioned so that the (s) polarized laser beam 111 being transported by the fiber 110 is directed by a beam deflection element 160 into normal incidence upon a second spatial location 152 of the input face 154 of the PBS element 150.

The crystal orientation of the PBS element 150 is such as to allow the (p) polarization laser beam 101 to pass therethrough along its input beam travel path, exiting face 155 at a location 153 that is path-coincident with its entry location 151 at the input face 154, and normal to each of parallel faces 154 and 155 of the PBS 150. On the other hand, the travel path of the orthogonal (s) polarization beam 111 is spatially translated or displaced through the crystal element 150 toward the travel path of beam 101. The length of PBS element 150 is defined such that the translated beam 111 intersects beam 101 and exits the crystal face 155 at the same exit location 153 as the beam 101, and is also normal to the exit face 155 as is the untranslated beam 101. This makes the two (mutually polarized) laser beams 101 and 111 path-coincident as a composite beam emerging from the same exit location 153 of the PBS combiner along a common travel path 156.

In accordance with the beam-combining, depolarization architecture of FIG. 4, the composite beam traveling along path 156 is normally incident upon location 171 of the front planar face 174 of a (polarization scrambling) high-order 45° waveplate 170. As pointed out above with reference to FIG. 1, the length of high order 45° waveplate 170 is defined so that the DoP of a composite beam 176 emerging from location 172 at the planar rear surface 175 of the waveplate will be less than ten percent, so as to provide for efficient coupling with a downstream Raman amplifier (not shown). Again, for typical 2 mm long, Raman pump Fabry-Perot lasers sourcing the two beams 101 and 111 and having a mode spacing on the order of from 0.15 to 0.20 nanometers (nm), 45° waveplate 170 may have a length on the order of 16 mm between its input face 174 and its exit face 175, which is parallel to the input face 174 and orthogonal to the beam path 156. The depolarized composite beam 176 exiting the 45° waveplate 170 is directed upon an optical fiber coupler 180, which couples the beam to an output single mode fiber (SMF) 190 over which the depolarized beam may be transported to a Raman amplifier.

FIG. 5 diagrammatically illustrates a second embodiment of an integrated beam combiner and depolarizer architecture in accordance with the present invention, having the same front end combining components as the embodiment of FIG. 4. However, the embodiment of FIG. 5 employs a modified composite beam-depolarizing structure, having a reduced thickness half-wave plate, in combination with components that increase the differential path length of one-half the power in split beam components to produce the intended polarization-dispersion effects on a multimode laser beam, shown in FIGS. 2 and 3, described above.

For this purpose, the embodiment of FIG. 5 installs a pair of beam-splitter-combiner crystals 210-220 downstream of a 22.5° half-wave plate 200. As in the embodiment of FIG. 4, in the embodiment of FIG. 5, respective polarization maintaining fibers (PMFs) 100 and 110 sporting carrying the first and second mutually orthogonally linearly polarized (p)/(s) multimode light beams 101 and 111 are terminated by way of collimator elements 120 and 130 of the combiner/depolarizer support structure 140.

However, rather than being incident upon a high-order 45° waveplate of a length sufficient to produce the intended degree of depolarization, the composite beam exiting the walk off PBS crystal element 150 is incident upon a 22.5° half-wave plate 200, having its optical axis rotated at 22.5° relative to the directions of polarization of the components of the incident composite beam. The 22.5° crystal element 200 serves to effectively reverse the planes of polarization of the two input beams (rotating each polarization by 45°) without causing beam displacement.

As a result, the mutually orthogonal polarization (p)/(s) beams pass through the polarization rotating crystal element 200 along the same input beam travel path, exiting rear face thereof at the same path-coincident exit location, but with polarizations reversed. The polarization-modified composite beam exiting the 22.5° half-wave plate 200 impinges at normal incidence upon location 211 of a planar input face 214 of a further PBS crystal element 210, which serves as a depolarizer, splitting one-half the power in each the two polarization components into separate travel path directions, so as to impart a differential transmission delay therebetween. The travel path of one-half the power in each beam component is straight through PBS element 210 to a first exit location 212 of planar exit face 215, while the travel path of the other half of the power of each beam component is displaced or translated over a longer distance through the PBS element 210 to a second exit location 213 of exit face 215, spaced apart from the first exit location 212.

The two differentially delayed beam components are incident upon respective spaced apart locations 221 and 222 of the front face 224 of a downstream PBS crystal element 220. The length of PBS beam combiner element 220 is the same as that of the depolarizer PBS crystal element 210, so that the two beam components will emerge the downstream combiner at the same exit location making the two (mutually orthogonally polarized (p)/(s)) beam components path coincident. As described above, because the lengths of the two PBS elements increase the length of the travel path of one-half the optical power in one path over one-half the optical power in the other beam path, there is an effective polarization dispersion of the two components of the beam, so that the DoP of the composite beam exiting the downstream crystal element 220 is substantially reduced, yielding the desired combined and depolarized output beam.

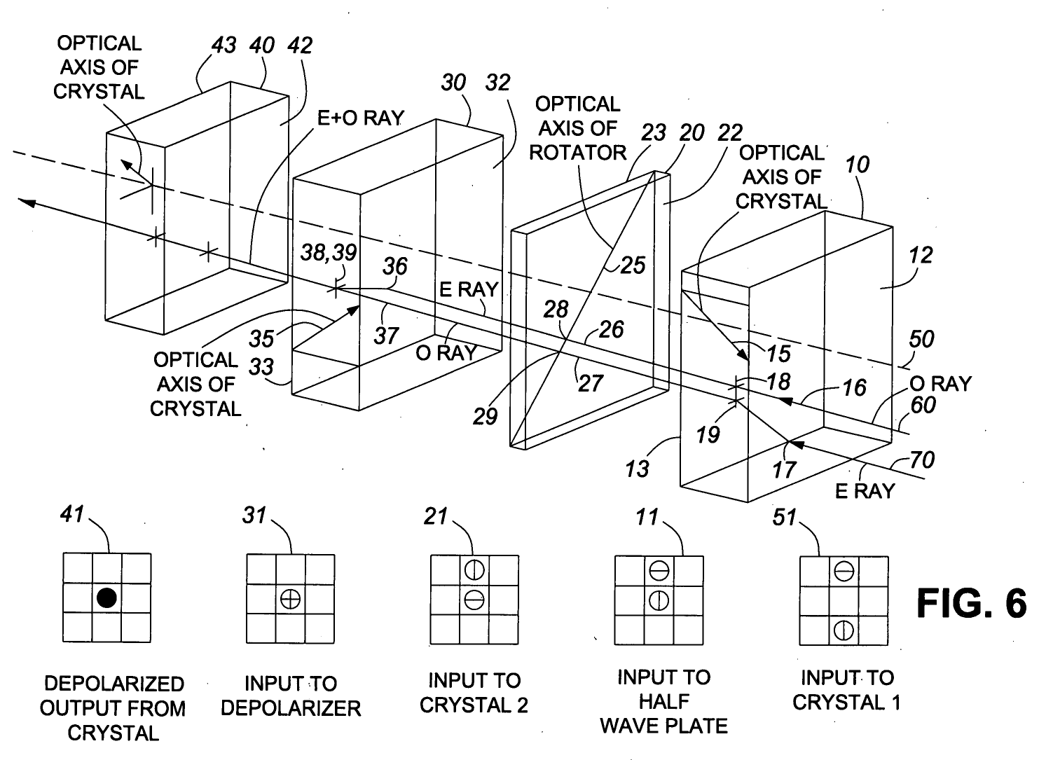

FIG. 6 is an exploded view of a third embodiment of a relatively compact implementation of an integrated beam combiner depolarizer architecture in accordance with the present invention, that incorporates aspects of the first and second embodiments of FIGS. 4 and 5, described above. As shown in FIG. 6, the integrated combiner-depolarizer structure of the third embodiment comprises an optically cascaded set of relatively thin beam-modifying crystal elements 10-20-30-40. Respective front and rear faces of these crystal elements are parallel to one another and orthogonal to an optical transmission axis 50 passing through the crystal elements of the combiner-depolarizer. The optical transmission axis 50 is preferably located generally in the middle of surfaces of the stack or cascaded of crystal elements, so as to minimize potential edge effect errors. By relatively thin is meant that each crystal element has an axial thickness lying in a range on the order of from 0.1 mm to 1 mm for crystals 10, 20 and 30, where crystals 10, 20 and 30 are placed in diverging space and crystal 40 is placed in collimated space, for combining light from inputs separated by approximately 125 microns, as is standard double fiber assemblies. The thickness of the depolarizer 40 can be made much thicker, for example 16 mm or more, if it is placed in a collimated region using lenses.

Also shown in FIG. 6 are beam polarization and position diagrams 11, 21, 31, 41 and 51 associated with the beam modifying characteristics of the respective crystal elements. In particular, the beam polarization and position diagrams 11, 21, 31 and 41 show the effects of the respective beam-modifying crystals 10-20-30-40 on a pair of multimode beams applied thereto, while the beam polarization, position diagram 51 shows initial (mutually orthogonal) polarization states of a pair of respectively spaced apart input beams 60 and 70, that are parallel to the optical axis 50 and are normally incident upon locations 16 and 17 of an input face 12 of the first crystal element 10 of the cascaded set.

As in the combiner depolarizer architectures of FIGS. 4 and 5, each of the multimode beams 60 and 70 may be provided by a respective multimode laser device, such as a 2 mm Fabry-Perot laser, referenced above, the outputs of which are coupled through an associated set of directing optics, such as optical fibers, associated lenses, path deflectors and the like, so as to precisely geometrically locate the incident locations 16 and 17 of beams 60 and 70 on the input face 12 of the crystal element 10. As in the above embodiments, crystal element 10 may comprise a conventional birefringent crystal element having its optical axis 15 oriented at 45° relative to its input and exit faces 12 and 13, as shown.

Similar to the walk-off crystal elements of the combiner depolarizer embodiments of FIGS. 4 and 5, the crystal element 10 in the cascaded set of FIG. 6 allows the beam 60 of a first polarization (e.g., horizontal as shown in the input beam polarization, position diagram 51) to pass straight therethrough along its input beam travel path, exiting face 13 at an exit location 18 that is path-coincident with its entry location 16 at input face 12. On the other hand the travel path of the orthogonally polarized beam 70 (e.g., vertical as shown in the input beam polarization, position diagram 51) is spatially translated through the crystal element toward the beam travel path of beam 60.

The beam 70 exits face 13 of the first crystal element 10 at an exit location 19 that is generally in the ‘middle’ of the dimensions of the crystal element 10 and is parallel to the travel path of beam 60. Being spatially positioned to be generally in the middle of the crystal element 10, beam 70 is spatially (e.g., vertically, as shown in the polarization, position diagram 11) offset relative to its entry location 17 of the crystal input face 12, and is considerably closer to (but not yet coincident with) beam 60.

Upon exiting crystal element 10, the two parallel (and more closely spaced) beams 60 and 70 are incident upon the input face 22 of crystal element 20. Crystal element 20 is configured as a 45° half-wave plate element, having its optical axis 25 being rotated at 45° relative to the directions of polarization of beams 60 and 70. As described above, being a 45° half-wave plate, crystal element 20 serves to effectively reverse the planes of polarization of the two input beams 60 and 70 (rotate each polarization by 90°) without causing beam displacement. As a result, each of beams 60 and 70 passes through the polarization rotating crystal element 20 along its respective input beam travel path, exiting face 23 at respective exit locations 28 and 29 that are path-coincident with entry locations 26 and 27 at input face 22, and having their polarizations rotated by 90° or effectively reversed, as shown in the polarization, position diagram 21.

The two polarization-reversed beams exiting the polarization rotation plate 20 are incident upon a third crystal element 30, which is identical to the first crystal element 10, having a thickness on the order of 0.5 mm to 1 mm for rutile or YVO₄ (0.628 mm for beams initially separated by 125 microns). The thickness will vary if different initial separation or different birefringent materials are used. The third crystal element 30 has its optical axis 35 oriented at 45° relative to its input and exit faces 32 and 33, as shown. Like crystal element 10, crystal element 30 allows the beam of a first polarization (e.g., horizontal) to pass therethrough along its input beam travel path, while causing the travel path of the orthogonally polarized beam (e.g., vertical) to be spatially translated toward the beam travel path of the horizontally polarized beam.

Since the original polarizations of the two input beams 60 and 70 have been reversed by the polarization rotator plate 20, the (horizontally polarized) beam 70 passes through crystal element 30 along its input beam travel path, exiting crystal face 33 at an exit location 39 that is path-coincident with its entry location 37 at input face 32. On the other hand, the travel path of the orthogonally polarized beam 60 (e.g., vertical as shown in the input beam polarization, position diagram 21) is spatially translated toward the beam travel path of beam 70, namely toward the middle of the crystal element 30.

As a result, the (vertically polarized) beam 60 exits crystal face 33 at an exit location 38 that is spatially (e.g., vertically, as shown in the polarization, position diagram 31) offset relative to its entry location 36 of the crystal input face 32. The dimensions (thicknesses) of the two crystals 10 and 30 are such that the exit locations 38 and 39 at the exit face 33 of crystal 30 are mutually coincident at a location that is generally in the middle of the crystal 30, as shown in the polarization, position diagram 31, to realize a composite beam containing mutually orthogonal polarization beam components.

This composite beam is incident at location 46 of the entry face 42 of a high-order 45° waveplate 40, such as a YVO₄ waveplate, described above. If placed in collimated space, the thickness may be on the order of 16 mm or more. If placed in converging space, the thickness is much smaller—on the order of 1 mm. (DoP is not randomized as much using a thin waveplate, yet it is useful in a configuration where the power of the two orthogonally polarized lasers are nearly equal). The optical axis of waveplate 40 is oriented at 45° relative to its planar and parallel input faces 42 and 43. The resultant depolarized output beam exiting face 43 is shown in polarization, position diagram 41. As in the embodiments of FIGS. 4 and 5, the resulting depolarized composite beam of the embodiment of FIG. 6 may be directed to an optical fiber coupler for application to an output single mode fiber.

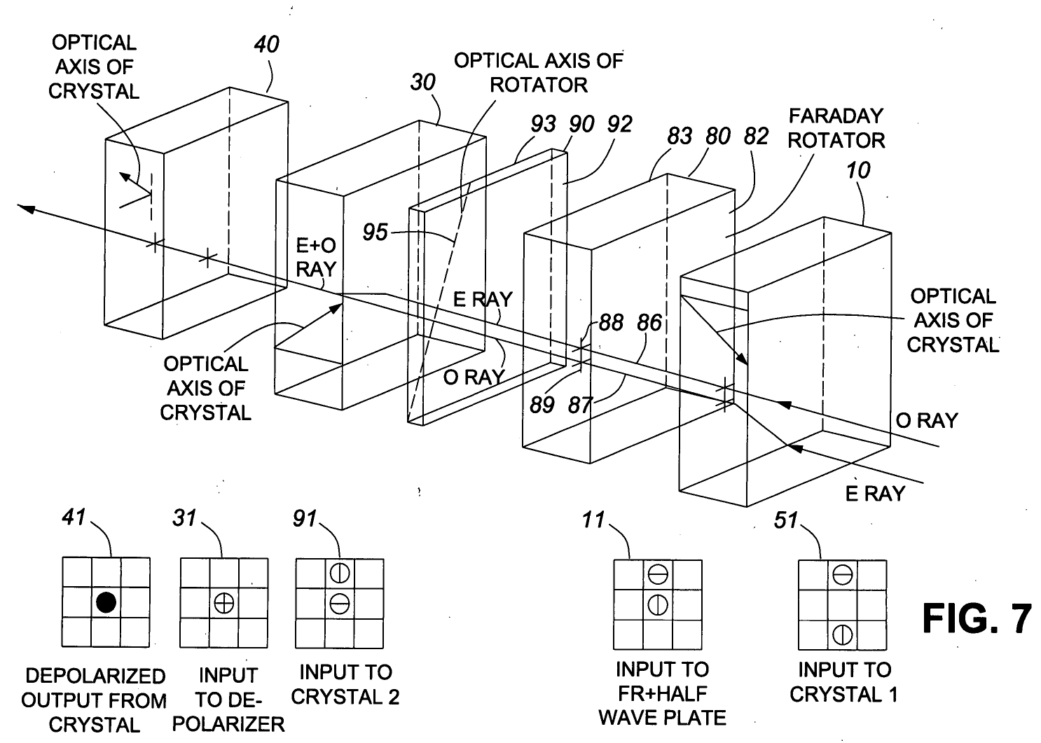

FIG. 7 is an exploded view of a fourth embodiment of the integrated beam combiner-depolarizer architecture of the present invention, in which the third embodiment of FIG. 6 is modified to provide reverse path isolation. This fourth embodiment contains the same first, third and fourth crystal elements 10, 30 and 40 of the third embodiment; consequently, these components will not be redescribed. To provide reverse path isolation, the second crystal element 20 of the third embodiment of FIG. 6 is replaced by a pair of optically cascaded crystal elements 80 and 90. Like the other crystal elements, these substitute components have their respective front and rear faces parallel to one another and orthogonal to optical axis 50. Also shown in FIG. 7 is a set of beam polarization, position diagrams 11, 21, 91, 41 and 51.

In the fourth embodiment of FIG. 7, the two beams 60 and 70 exiting the crystal element 10 are incident upon the input face 82 of a Faraday rotator element 80, which serves to provide the desired reverse path isolation, but allows the two beams incident upon input face 82 to travel along spatially parallel paths therethrough, exiting face 83 at respective exit locations 88 and 89 that are path-coincident with entry locations 86 and 87 at input face 82. Upon exiting Faraday rotator 80, the two parallel beams 60 and 70 are incident upon the input face 92 of a polarization rotator element 90. This embodiment is particularly convenient and cost effective to manufacture. The addition of the Faraday rotator in combination with the already present half waveplate in the previous embodiment provides a device which can be easily packaged, provides a high degree of depolarization and sufficient isolation with two input fibers and a single output fiber.

The polarization rotator element 90 (which is nearly a half-wave plate) has its optical axis 95 rotated at 22.5° relative to the direction of polarization of vertically polarized input beam 70, and 67.5° relative to the direction of polarization of horizontally polarized input beam 60. The combination of the Faraday rotator and the polarization rotator causes a rotation of 90° (45° by the Faraday rotator and 45° by the half-wave plate) relative to their polarizations as incident upon Faraday rotator 80, as shown in polarization, position diagram 91. The polarization-reversed beams exiting the rotator plate 90 are then incident upon the third crystal element 30, and coupled combined therein for application to high order 45° depolarizer waveplate 40 as in the embodiment of FIG. 6. Again, as in the embodiments of FIG. 6, the resulting depolarized composite beam may be directed to an optical fiber coupler for application to an output single mode fiber.

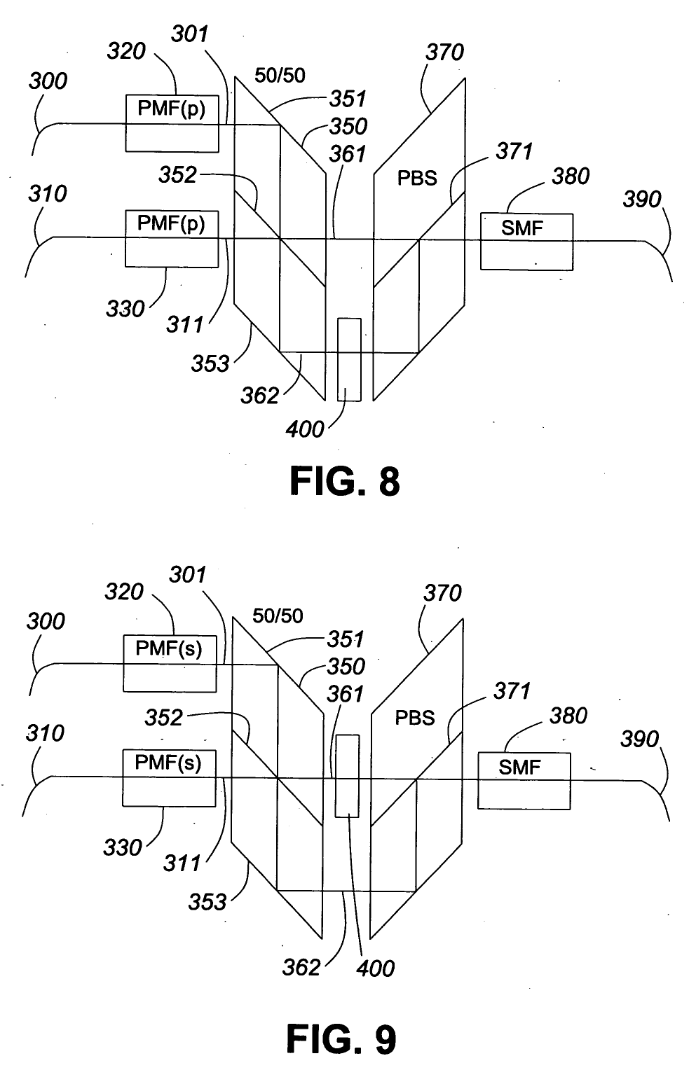

An integrated beam combiner and depolarizer architecture in accordance with a fifth embodiment of the present invention is diagrammatically illustrated in FIG. 8, wherein polarization maintaining fibers (PMFs) 300 and 310 carrying like, linearly polarized (p) light beams 301 and 311 sourced from the same or respective FP lasers are terminated by way of collimator elements 320 and 330 of a differential path length, combiner/depolarizer support structure. As in the above embodiments, the wavelengths of the two multimode laser beams may be different.

The collimator element 320 is positioned to direct the (p) polarized laser beam 301 transported by the PMF 300 to be incident upon a first totally reflective surface 351 of a 50/50 beam splitter block 350 having a (50/50) partially reflecting, partially transmitting, beam-splitting surface 352 and a further totally reflective surface 353. Similarly, the collimator element 330 is positioned so that the (p) polarized laser beam 311 transported by fiber 310 is directed upon the beam-splitting surface 352.

With the two input beams incident upon surfaces 351 and 352 in the manner described above, 50% of the beam 301 reflected from totally reflective surface 351 upon surface 352 is reflected by surface 352 along a first, relatively short, beam path 361, while the other 50% of the beam 301 reflected from totally reflective surface 351 upon the beam-splitting surface 352 passes through surface 352 and is reflected by totally reflective surface 353 along a second, relatively long (with respect to beam path 361), beam path 362, that causes the beam transported thereover to undergo a transport/phase delay relative to that traveling over the relatively short beam path 361.

Similarly, 50% of the beam 311 incident upon surface 352 passes therethrough along the short beam path 361, while the other 50% of the beam 311 is reflected by the beam-splitting surface 352 and directed by the totally reflective surface 353 along the long beam path 362. Namely, the 50/50 beam splitter block 350 produces two composite beams along paths 361 and 362, each containing 50% of each of the like (p) polarized input beams 301 and 311.

The composite beam traveling along the first (short) beam path 361 is directed at normal incidence upon a polarization-dependent reflective/transmissive surface 371 of a polarization-dependent combiner/splitter block 370. The polarization dependency properties of surface 371 are such that the (p) polarized beam traveling along beam path 361 is transmitted therethrough, while an orthogonal or (s) polarization beam is reflected thereby. Since the composite beam traveling along beam path 361 has (p) polarization, the entirety of that beam is transmitted through surface 371 onto a fiber coupler 380, which terminates output single mode fiber 390.

On the other hand the composite beam traveling along the second (long) beam path 362 is directed at normal incidence upon a 45° half-wave plate 400. Like the 45° half-wave plate elements of the above embodiments, half-wave plate 400 has its optical axis rotated at 45° relative to the direction of (p) polarization of the composite beam on beam path 362. Half-wave plate 400 serves to effectively reverse the plane of polarization of the composite beam on path 362, as shown, without causing beam displacement.

With the polarizations of its components rotated by 90°, the composite beam traveling on long beam path 362 is directed upon a first totally reflective surface 372 of the polarization-dependent combiner/splitter block 370, and reflected thereby so as to be incident upon the polarization-dependent reflective/transmissive surface 371. Since the polarization dependency properties of the surface 371 are such as to reflect an orthogonal or (s) polarization beam, the polarization reversed (s) beam of the long path 362 is reflected by surface 372, so as to be coincident with the (p) polarization composite beam traveling along path 361 onto the coupler 380, terminating the output fiber 390.

As a result of the different polarizations and differential phase delays of the beams of the two paths 361 and 362, the DoP of the composite beam produced by the polarization-dependent combiner/splitter block 370 will be substantially reduced (to a value less than ten percent), so as to allow the beam transported by fiber 390 to be readily coupled into a Raman amplifier and amplified thereby, as described above.

FIG. 9 shows a sixth embodiment of an integrated beam combiner and depolarizer architecture in accordance with the present invention, which is a polarization-complement version of the embodiment of FIG. 8, described above. Namely, in the embodiment of FIG. 9, the polarizations of the light beams 301 and 311 transported by the fibers 300 and 310 are linearly (s) polarized light beams 301 and 311. As in the embodiment of FIG. 8, the two light beams are split by the 50/50 beam splitter block 350 into two composite beams along paths 361 and 362, each containing 50% of each of the like (s) polarized input beams 301 and 311.

In the present embodiment, the 45° half-wave plate 400 is installed in the path of the composite beam traveling along the first (short) beam path 361, and serves to effectively reverse the plane of polarization of the composite beam on path 361 to (p) polarization, as shown, without causing beam displacement. On the other hand, the composite (s) polarization beam traveling along the second (long) beam path 362 is directed upon the polarization-dependent reflective/transmissive surface 371 of the polarization-dependent combiner/splitter block 370.

Since the composite beam traveling along beam path 361 now has (p) polarization, the entirety of that beam is transmitted through surface 371 and onto the fiber coupler 380, which terminates output single mode fiber 390, as in the embodiment of FIG. 7. Also, the polarization reversed (s) beam of the long path 362 causes the beam to be reflected by the surface 372, so as to be coincident with the (p) polarization composite beam traveling along path 361 onto the coupler 380, terminating the output fiber 390. Again, due to the different polarizations and phase delays of the respective (p) and (s) polarization beams of the two paths 361 and 362, the DoP of the composite beam produced by polarization-dependent combiner/splitter block 370 will be substantially reduced to allow the beam transported by fiber 390 to be readily coupled into a Raman amplifier and amplified thereby, as described above.

As will be appreciated from the foregoing description, by combining a 45° waveplate with a set of polarization-based beam combiner/splitter components, the integrated multimode laser beam combining and depolarization architecture of the present invention is effective to combine a pair of polarized multimode laser beams into a composite output beam that is effectively depolarized to a value of less than ten percent, so that it is optimized for application to a depolarization-based device, such as a Raman optical amplifier.

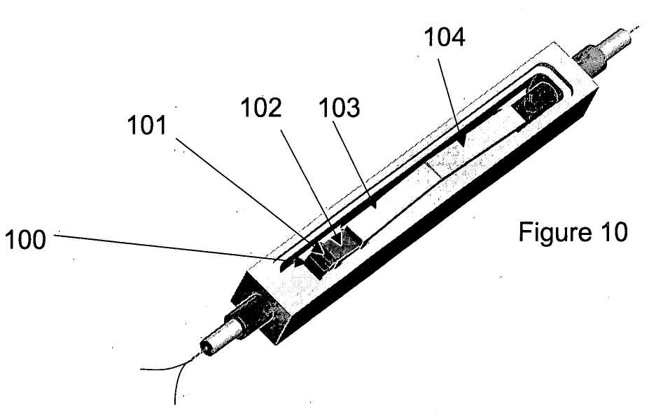

Referring now to FIG. 10 a packaged polarization depolarizer in accordance with a preferred embodiment of the invention is shown. At a first end of the packaged device is a beam combiner formed of a Wollaston prism 100, 101 and a walk-off crystal 102. Since the cost of high order waveplates increases with length, conveniently, two high order waveplates 103 and 104 are juxtaposed to each other. The crystals are tilted with opposite sign such that they are plus and minus 2 to 3 degrees to the propagation axis, i.e. the Z-axis. The optical axes of the crystals are in the x-y planes.

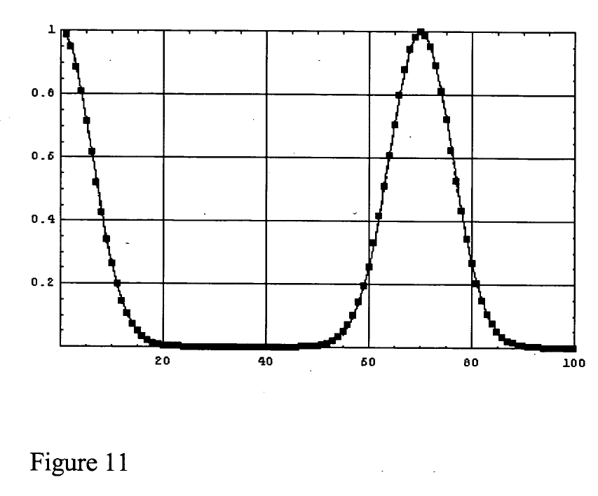

FIG. 11 shows a plot of depolarization versus thickness for a crystal having a difference in refractive index between the extraordinary and the ordinary axes or 0.2. The periodic nature of the output spectrum as a depolarizer with changing length is evident for the high order waveplate. Thus the length must be carefully selected so as to depolarize the input beams. The length is also selected in dependence upon the wavelength band of interest. The plot of FIG. 11 is a simulation result of DoP vs. length in unit of mm curve for Δn=0.2, Δλ=0.15 nm (the Fabry Perot mode spacing the pump laser), λ=1450 nm.

The length of the crystal is optimized at

$$\frac{{λ}^{2}}{2 Δ n Δλ} = 35 mm .$$

The minimal crystal length is 20 mm as is evident from the plot.

While we have shown and described a number of embodiments of the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

What is claimed:

1. A polarization dependent depolarizer for depolarizing two linear orthogonally polarized incoming beams of light, comprising:
a) a housing having polarization maintaining input optical fibers for providing polarized light into the housing and an output optical fiber for directing a single depolarized beam out of the housing;
b) a polarization beam combiner disposed within the housing and oriented to receive the two linear orthogonal components of light exiting the input optical fibers and for combining the two beams into a single beam;
c) a first high order depolarizing waveplate having a principle optical axis and having a length along said axis so as to achieve depolarization of a beam propagating entirely along said axis such that the DoP of the beam exiting the first high order depolarizing waveplate is less than 20 percent, whereby different wavelengths of light in said beam will have a different polarization than other wavelengths in said beam, said waveplate having ordinary and extraordinary indices of refraction, a difference of said indices of refraction being at least 0.1, said first high order depolarizing waveplate being oriented such that orthogonally linear components of the beam received from the polarization beam combiner are at substantially 45 degrees to the optical axis of the first high order depolarizing waveplate, wherein in operation, light exiting the first high order depolarizing waveplate is optically coupled to the output optical fiber.

2. The polarization dependent depolarizer as defined in claim 1 wherein a second high order depolarizing waveplate is disposed within the housing oriented to have its principle axis optically aligned with said first high order depolarizing waveplate to receive an output beam therefrom, in operation, the beam after propagating through the first and second high order depolarizing waveplates having a DoP of less than 10 percent.

3. The polarization dependent depolarizer as defined in claim 1 further comprising a non-reciprocal rotating means disposed within said package and in line with the a first high order depolarizing waveplate for preventing a substantial portion of any light propagating in a direction toward the input optical fibers from coupling to said optical fibers.

4. The polarization dependent depolarizer as defined in claim 2 further comprising a non-reciprocal rotating means disposed within said package and in line with the a first high order depolarizing waveplate for preventing a substantial portion of any light propagating in a direction toward the input optical fibers from coupling to said optical fibers.

5. The polarization dependent depolarizer as defined in claim 3, wherein polarization beam combiner is a beam combiner/splitter and wherein the beam combiner/splitter and the non-reciprocal rotator form an optical isolator for substantially preventing back reflections from coupling into the polarization maintaining input fibers.

6. The polarization dependent depolarizer as defined in claim 2, wherein the difference in index of refraction of ordinary and extraordinary axes of the high order waveplate is about 0.2 or greater.

7. The polarization dependent depolarizer, wherein said high-order depolarizing 45° waveplate has a length defined in accordance with the mode spacing of the incident beam, so as to realize an output beam having a degree of polarization (DoP) of less than ten percent.

8. The polarization dependent depolarizer as defined in claim 2, wherein the first and second high order depolarizing waveplates have non-parallel inwardly facing end faces for reducing back reflections from coupling back into the first high order waveplate by unwanted etalon effects.

9. The polarization dependent depolarizer as defined in claim 8, wherein the first and second high order depolarizing waveplates are disposed within the package such that they are offset from each other to lessen the unwanted effects of back reflections.

10. The polarization dependent depolarizer as defined in claim 6, wherein the beam combiner comprises a Wollaston prism.

11. The polarization dependent depolarizer as defined in claim 10, wherein the beam combiner further comprises a walk-off crystal for overlapping the two input beams of light.
